(19) United States
(12) Patent Application Publication
(10) Pub. No.: US 2013/0016861 A1
(43) Pub. Date: Jan. 17, 2013

(54) HEARING AID WITH OPTICAL SIGNAL TRANSMISSION AND CHARGE SYSTEM WITH OPTICAL SIGNAL TRANSMISSION

(71) Applicant: Holger Kaempf, Buxtehude (DE)

(72) Inventor: Holger Kaempf, Buxtehude (DE)

(73) Assignee: HANSATON AKUSTIK GMBH, Hamburg (DE)

(21) Appl. No.: 13/549,145

(22) Filed: Jul. 13, 2012

(30) Foreign Application Priority Data
Jul. 15, 2011 (DE) 10 2011 107 780.8

(51) Int. Cl. H04R 25/00

(52) U.S. Cl. 381/315

(57) ABSTRACT

A hearing aid including a hearing aid housing in which is arranged a transmitter unit for transmitting signals containing information to a receiver unit which is outside of the hearing aid. The transmitter unit generates an optical signal in the visible or outside of the visible spectral range and includes a signal generator for generating the optical signal and a modulator for modulating information onto the optical signal. The hearing aid housing includes a signal exit window that is transparent to the optical signal and through which the signal penetrates. The signal exit window has an entrance surface facing the inside of the housing through which the signal enters into the signal exit window, and an exit surface that matches the external contour of the hearing aid housing through which the signal exits from the signal exit window.

### BACKGROUND OF INVENTION

1. Field of Invention

The invention relates to a hearing aid with optical signal transmission as well as a charge system with optical signal transmission.

2. Description of Related Art

From prior art it is known to transmit the incidental information in a hearing aid to peripheral equipment on the outside, such as charge, programming, or diagnostic equipment, in order to draw conclusions from this information regarding the operating status of the hearing aid, for example. It is particularly known that with hearing aids which have rechargeable batteries to measure the voltage on the battery during the charging process, for example, to transmit this voltage information to the outside to the external charge unit and to optimally control the charge process by means of the transmitted information. The transmission of the information can be by means of hard-wiring, for example, in that a charge cable is connected to the hearing aid, which is not just used for providing the charge current but also but also to retransfer the information determined in the hearing aid. Such hearing aid that is suitable to be connected to a charge unit is described in US 2006/0256989. There it is also explained that the charge process of the battery is controlled by using the charge information which is determined in the battery in the hearing aid and is provided to the charge unit, as well as the associated benefits.

As a rule, modern hearing aids are charged without making contact, such as is shown in DE 297 18 104 U1, for example. With these hearing aids, the transmission of information should also be cordless, especially since with the increasing trend of hearing aid miniaturization, it should be possible to do away with the cumbersome connection of cables.

EP 0 909 113 A2 shows an inductively chargeable hearing aid with a transmitter coil in the charge unit and a receiver coil in the hearing aid, in which the rechargeable battery of the hearing aid is connected with a voltage measurement instrument. The voltage values measured are inductively transmitted from the hearing aid to the charge unit outside, and the charge process is controlled by means of the transmitted information. The inductive transmission occurs by means of the already provided transmitter and receiver coils for the energy transfer. DE 10 2008 023 352 A1 represents similar prior art, which comprises an antenna for the energy and signal transmission for wireless transmission and receiving of electromagnetic signals. In this prior art it is considered to be a disadvantage that the transmission is susceptible to interference, since the hearing aid is located in an external magnetic field. The generic, optical transmission proves to be also more cost-effective, since no additional transmitter coil is necessary and no big effort for dealing with interferences is necessary.

U.S. Pat. No. 7,620,195 B2 shows an acoustic information transfer between hearing aid and charge unit. It is considered disadvantageous that for this purpose additional acoustic transmitter and receiver elements must be used that are comparatively susceptible to errors and external acoustical interferences.

A generic prior art with optical signal transmission is known from EP 1 727 395 B1. Apart from other alternative methods for information transmission which correspond to the above prior art, it is also proposed to arrange a light source in the hearing aid and a phototransistor in the charge unit and to let the light source emit a modulated signal which after reception is demodulated by the phototransistor. This document does not disclose further details regarding this optical signal transmission and about the arrangement of the optical transmitter and the optical receiver.

DE 10 2005 020 322 shows an optical interface between a hearing aid and an external unit. For this purpose, several light emitting diodes (LEDs) are flush-mounted into the housing on the outside of the hearing aid, and on which corresponding receiver diodes are located opposite on the sides of the external unit. This optical interface in principle represents an optical connector. The complex design, the sensitivity against soiling, and the space requirements are considered to be disadvantageous. A precise alignment between the multiple adjacently arranged transmitters and receivers must also be ensured.

The object of the present invention is to provide a hearing aid with optical signal transmission that takes into account the tight space in a hearing aid and eliminates the disadvantages indicated.

### BRIEF SUMMARY OF THE INVENTION

This object is accomplished with a hearing aid as disclosed herein as well as by a charge system as disclosed herein.

According to the prior art it is provided that an optical transmitter on the side of the hearing aid and an external optical receiver are aligned reciprocally such that the optical signal emitted from the transmitter is pointed at the receiver. This is particularly clearly shown by DE 10 2005 020 322. For this reason, the optical transmitter must have a certain arrangement and alignment in the hearing aid relative to the external optical receiver. It is therefore not possible to arrange the transmitter optionally at any preferred position, due to space reasons, for example, such as on a printed circuit board on the inside of the hearing aid which normally has to be provided anyway, and on which some or all of the electronic components of the hearing aid are arranged. This option exposes the design as taught by the invention, in that in addition to the optical transmitter a signal conductor is arranged in the hearing aid, which conducts the optical signal emitted from the transmitter to a signal exit window in the hearing aid housing. As a result, the transmitter can be arranged in any optional position in the hearing aid, in particular on a printed circuit board, on which also other electronic hearing aid components are arranged. The invention therefore allows some liberties in terms of design with respect to the arrangement of the necessary optical transmission and receiving means.

The signal conductor has the function to pick up the signal emitted from the optical transmitter in a beam direction and to supply it to the signal exit window in the hearing aid housing. For this purpose, the signal conductor is to conduct the signal such that the signal exit from the signal exit window occurs in the direction of the optical receiver, in that the direction of signal propagation is changed during the guidance in the signal conductor from the original direction of propagation of the signals emitted by the transmitter to an exit direction on the signal exit window.

The invention teaches that the information transfer occurs via an optical signal. This optical signal can synonymously also be denominated as “light,” the signal conductor also as light conductor, for example, the signal exit as light exit window, etc. Under optical signal and or/or under light, however, this does not simply comprise only the visible (VIS) optical spectral range but also the infrared (IR) spectral range which lies in the higher wavelengths as well as the ultraviolet (UV) spectral range which lies in smaller wavelengths.

Preferably, light in the infrared spectral range is used, for example, at a peak wavelength of 950 nm. This wavelength range has advantages, since interferences due to the visible beam range of the daylight or from fluorescent lights or from other sources of artificial light can be avoided, if the charge station is not enclosed. Since the hearing aid is worn during the day, it is therefore normally charged at night. If visible light is used, the person wearing the hearing aid may object to this during the night hours. For this purpose, appropriate transmitters and receivers are therefore available on the market in a small and convenient shape, and suitable construction materials for the signal exit window are also known in the prior art.

A signal conductor within the context of the present invention can be an optical fiber or a cluster of optical fibers, for example, which leads from the light source to the light exit window. For example, an optical fiber can be bonded on the fiber inlet side to an LED that generates the light signal and operates in the infrared range, and on the fiber exit side to the light exit window. But this can also involve one mirror or multiple mirrors. Preferred is the light conductor, which is however formed as a rigid fiber-optic body from a material that is transparent for the optical signal, with an entrance surface and an exit surface. In particular, there are advantages in terms of manufacture and assembly, because no complex steps in terms of assembly, adjustment, or bonding are necessary, for example, such as when using mirrors or optical fibers. The signal falls onto the entrance surface of the fiber-optic body and then proceeds in the interior up to the exit surface. Both of these surfaces have non-parallel surface normals. During entry into the fiber optic body, the light is refracted due to the refractive index difference, and if necessary a further reflection occurs on the exit side of the fiber-optic body, for example, because the fiber-optic body and the light exit window are made from materials with a different refractive index, or because an air gap remains in-between. The material of the fiber-optic body, and here especially the refractive index, and the inclination of the entrance surface to the beam direction are selected so that the refraction of the optical signal occurs towards the surface normal of the signal exit window, so that the light is refracted in the direction towards the external opto-receiver. On the path from the entrance surface to the exit surface, the signal can also still be reflected from the side faces of the fiber-optic body, for example, which are provided with a mirrored surface for that purpose, for example. The guidance in the fiber-optic body can also occur without internal reflections, however, which is advantageous because of the associated reduced light loss.

It is preferred that the light and/or signal exit window forms the wedge-shaped fiber-optic body in the hearing aid housing. For this purpose, it extends from its signal exit window wedge-shaped in the direction to the light generation means and its entrance area lies in the beam direction of the signal generation means such that the emitted signal impinges on the entrance surface, continues within the window, and exits again on the exit surface. For this purpose, the guidance in the window interior occurs preferably without reflection on the side faces of the window. With this construction, the entrance and exit surfaces of the fiber-optic body preferably coincide with the entrance and exit surfaces, because the signal exit window forms the fiber-optic body. The advantage is that the signal exit window and the fiber-optic body can be produced as one piece which results in a simplified assembly.

The manufacture is particularly easy if the signal exit window is produced from a synthetic material that is transparent for the optical signal. Suitable synthetic materials for infrared light, for example, are sufficiently known in the prior art. For example, transparent acrylic (PMMA) or transparent ABS can be used, such as the thermoplastic material known by the trade name Terlux, and in this instance particularly Terlux 2812. Also other materials used in the sector of plastic glazing can be considered.

A further improvement in the manufacture and assembly results when the hearing aid housing is produced from the window material of the signal exit window, and the hearing aid housing and the signal exit window are formed as one piece and the signal exit window is designed as an integral component of the hearing aid housing. It is therefore possible to produce an assembly consisting of hearing aid housing, signal exit window, and fiber-optic body, because everything is produced from one material and in one piece. But it is also not impossible that the entire housing of the hearing aid is designed in several parts. This is moreover rather provided as a rule, in order to obtain lockable access openings for the assembly or for potential repairs of the hearing aid. The hearing aid normally has a battery compartment, for example, which must be opened for easy battery replacement. It is merely necessary that the hearing aid housing area with the signal exit window and the fiber-optic body is produced in one piece. Only this area is therefore specifically referred to as the ‘hearing aid housing.’ The hearing aid housing can obviously also be designed as being entirely closed, i.e. particularly without the battery compartment.

Because of the one-piece design, the choice of material of the signal exit window also determines the housing characteristics of the hearing aid. The outer surface of the hearing aid housing is painted or coated or imprinted except for the signal exit window to improve the hearing aid housing for reasons of design, handling or durability. The manufacture is easier when when the surface of the hearing aid housing is produced by completely painting or coating or imprinting the surface followed by subsequently removing the painting, coating or imprinting from the signal exit window.

It is particularly advantageous when the hearing aid comprises a rechargeable battery and a charging circuit with energy receiving means which operate without making contact, and with acquisition means for detecting a charge status of the battery, wherein the modulation means is in communication with the acquisition means and modulates information onto the signal regarding the charge status. The optical signal is used for the transmission of charge information in that corresponding information is modulated on it. It is possible to modulate the signal luminance or the frequency, for example, or the signal is switched on and off, for example by switching the optical transmitter on and off with a suitable LED, for example, or by blocking the beam path by an aperture which opens and closes. The voltage of the battery can be detected by a voltmeter, for example, and these measured results be provided to a modulator unit. This modulator unit can then modulate this information onto the optical signal by corresponding activation of the LED or of blocking means arranged in the beam path. The communication between the modulator unit and voltmeter can be unilateral, or merely measured values are supplied to the modulator unit, for example.

For convenience, the hearing aid further comprises counting means for detecting the number of charge cycles or the charge cycles that are still remaining, and wherein the modulation means is in communication with the counting means and modulates information regarding the number of charge cycles or the charge cycles still remaining onto the signal. The counting means can be a simple memory, for example, in which the number of charge cycles is filed and/or is incremented, and/or the number of cycles that are still possible are filed or are decremented. This information is useful, for example, to indicate early enough on the charge unit that the battery should be replaced, using suitable indicating means such as a display or indicator LEDs. In this case, the communication can also be limited so that the modulator unit reads out and/or receives this number from the memory, for example. The charge unit can also indicate, for example, that the hearing aid should be serviced, such as to perform a cleaning procedure, replace the filter on the microphone, or also replace the battery.

The charge system comprises a charge station and a hearing aid as disclosed herein, wherein the charge station comprises the receiver unit and a demodulation means for reading out the information modulated on the transmitted signal. The charge station can have suitable indication means, for example, in order to display the received information to a user completely or partially in the form of a display or in the form of LEDs, for example.

### BRIEF DESCRIPTION OF THE DRAWINGS

In the following, the invention is to be further explained by means of two embodiments, as follows:

FIG. 1 shows a first embodiment of a hearing aid as taught by the invention as a highly simplified diagrammatic representation, and

FIG. 2 shows a second embodiment of a hearing aid as taught by the invention as a highly simplified diagrammatic representation.

### DETAILED DESCRIPTION OF THE INVENTION

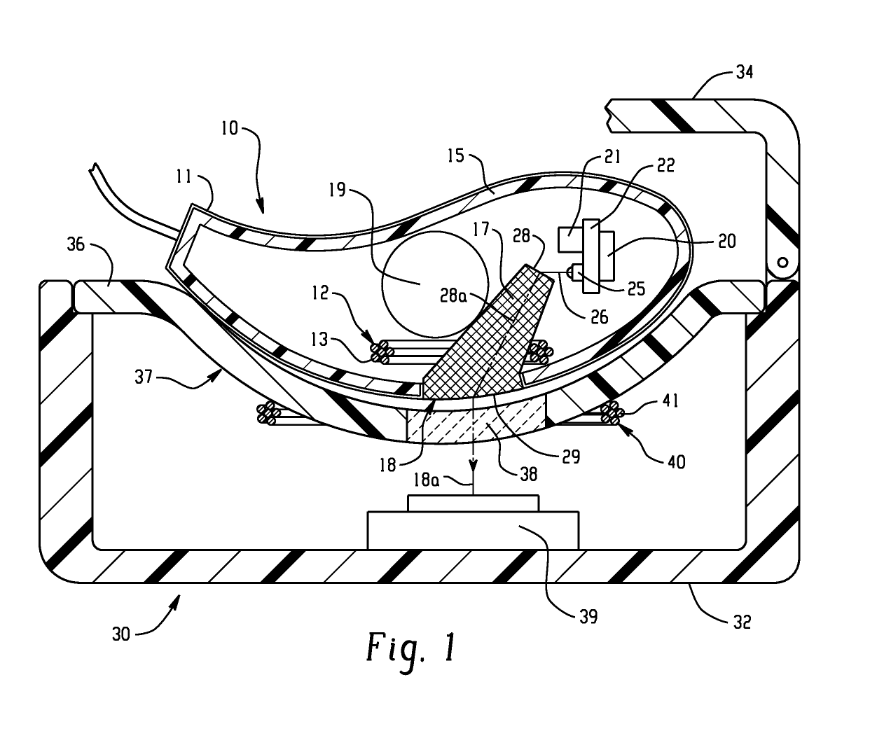

FIG. 1 shows a first embodiment for a hearing aid 10 that has been placed onto a charge station 30. The charge station 30 consists of a housing bottom part 32, onto which a housing cover 34 is attached by means of a pivot joint. The housing furthermore has a holding pan 36 which is supported by the housing bottom part 32, which has the receptacle 37 which accommodates a hearing aid 10 and the shape of which is matched to the contour of the hearing aid to the extent possible, and in which an aperture 38 is formed. Below the aperture 38 is a photodiode 39, which, in the embodiment shown is sensitive to infrared light, for example. Evaluation means and control means (not shown) are arranged in the charge station 30 to read-out and process the signal of the photodiode 39.

Furthermore, a transmitter coil 40 is arranged in the charge station 30 which surrounds the hearing aid receptacle 37, which in FIG. 1 is indicated by a few windings of wire 41. The electrical and electronic components to supply this transmitter coil 40 with current and the transmission of energy by means of this transmitter coil 40 to a receiver coil 12 with windings 13 arranged in the hearing aid 10, are not represented. The supply mains line between the charge station 30 and an external current source, such as a mains plug of customary design, for example, is also not represented.

In the illustrated first embodiment, a hearing aid 10 in the charge position is inside the charge station 30. For this purpose, it lies in the receptacle 37 of the charge station 30 which is matched to the external contour of the hearing aid housing 15. In this position, the aperture 38 of the charge station 30 and a signal exit window 18 formed in the hearing aid housing 15 are reciprocally opposite such that light from the exit window 18 from the hearing aid 10 impinges on the photodiode 39. The holding pan 36 can for instance consist of an infrared-permeable synthetic material and can therefore serve as an aperture in its entirety.

The hearing aid 10 furthermore comprises a rechargeable battery 19. Pursuant to the embodiment, the charging is to occur without contact. For this purpose, a receiver coil 12 with coil windings 13 is arranged in the hearing aid such that energy transmitted by the transmitter coil 40 can be received inductively and be supplied to the battery 19 by means of a suitable charging circuit 20. The charging circuit 20 is arranged on a printed circuit board 22, on which a control 21 as well as an LED 25 which emits light in the infrared spectral range is furthermore arranged. The beam direction 26 of the LED 25 in the embodiment shown runs approximately perpendicular to a line defined by the surface normal 18a of the exit window 18 where the optical beam exits, so that any light emitted from the diode 25 would not reach the photodiode 39 directly.

In the illustrated embodiment, the signal exit window 18 on its external surface of the hearing aid is designed flush with the hearing aid housing 15, while the signal exit window 18 on the inside the hearing aid extends wedge-shaped in the direction towards the LED 25. The wedge-shaped window 18 comprises an entrance surface 28, which is located in the beam direction 26 of the diode 25 and onto which infrared light is therefore applied. The wedge-shaped formed window 18 furthermore has an exit surface 29, which is flush with the outside of the hearing aid. The entrance surface 28 is tilted towards the beam direction 26 of the diode 25, so that a refraction occurs when the infrared light enters into this wedge-shaped extension 17 of the signal exit window 18. In this context, the window material and the tilt angle of the entrance surface 28 towards the beam direction 26 of the diode 25 are selected such that the refraction occurs in the direction to the photodiode 39 and/or in the direction to the surface normal 18a of the exit surface 29. As shown in FIG. 1, the refracted optical signal 28a travels between the point where the optical signal traveling in the beam direction 26 from the diode 25 contacts the entrance surface 28 of the wedge-shaped extension 17 to the point where the refracted optical signal 28a exits the exit surface 29 and travels along the normal to such point on the exit surface 29.

By means of appropriate material doping it can be provided, for example, that the infrared light is refracted once more in direction to the photodiode 39 prior to the exit from the exit window 18. But also by different material selection for the exit window 18 and aperture 38, for example, an additional refraction can occur during the transition of the infrared light in direction to the photodiode 39. If such refraction is no longer required, a reflection on the side faces can also be provided in the signal exit window 18, particularly in the wedge-shaped extension 17, for example, which can be provided with an appropriate reflective coating for this purpose, for example.

The light emitting diode 25 is activated by the control device 21, which modulates information onto the continuous light signal, by intensity modulation, for example. Alternatively, the light emitting diode 25 could also be switched on and off by the control device 21 by means of information transmission, or the frequency could be modulated.

The information modulated onto the infrared light of the light emitting diode 25 by the control device 21, for example can contain information about the charge status of the battery 19. For this purpose, the control device 21 is connected with the charging circuit 20, to receive information about the voltage status of the battery or regarding the charge current, for example. The control device 21 can furthermore have a memory at its disposal, for example, in which the number of charge cycles is filed, or which has information as to how many charge cycles are still possible. The control device 21, by corresponding activation of the light emitting diode 25, can also modulate this information onto the emitted infrared light.

The photodiode 39 comprises suitable demodulation means to be able to read out the information modulated onto the received infrared light. This information can be forwarded to the control of the transmitter coil 40 and/or the charge current control, for example, in order to adapt the electrical energy transmitted to the receiving coil 12 to the charge status of the battery 19.

The transmission of information by using infrared light, which is mentioned here merely by way of examples, can obviously also occur in the visible or ultraviolet range. A plurality of suitable light emitting diodes and photodiodes are known in the prior art for use in these alternative ranges of wavelengths.

In the illustrated embodiment, the housing 15 of the hearing aid 10 is produced from the same material as the signal exit window 18. In particular the hearing aid housing 15 including exit window 18 and the wedge-shaped extension 17 of the window 18 in direction towards the light emitting diode 25 is designed as one-piece, wherein this is also to comprise that any areas of the hearing aid housing 15 which do not relate to the signal exit window can be removed, for example, to be able to replace the battery 19 or to be able to work inside the hearing aid for purposes of repair or installation.

Furthermore, in the illustrated embodiment, the hearing aid housing 15 on its outside has a coating 11. This coating 11 has not been applied merely to the area of the exit window 18. This can be accomplished, for example, in that following a complete coating of the hearing aid housing 15 including the signal exit window 18 produced from a transparent synthetic material, the coating 11 is subsequently removed from the window area again, such as by laser machining. It is also possible to protect the window area against coating by masking it beforehand and then subsequently remove the masking.

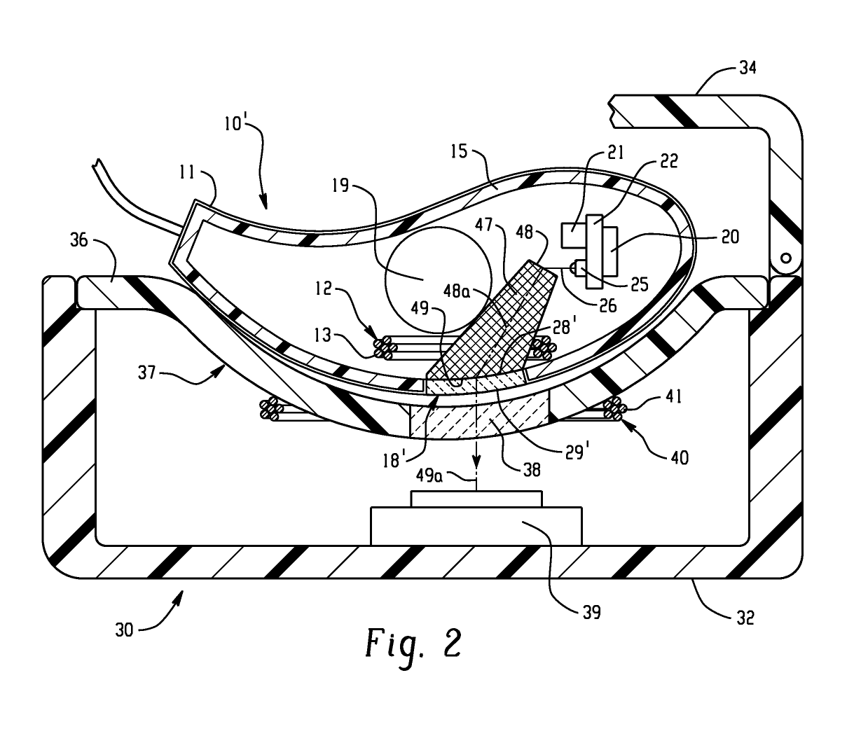

FIG. 2 represents a second embodiment for a hearing aid 10′ as taught by the invention. The charge unit 30 illustrated in FIG. 2 is identical to the charge unit illustrated in FIG. 1. The hearing aid 10′ illustrated in FIG. 2 is also identical to the hearing aid 10 illustrated in FIG. 1, except for the window area. For this reason, the reference symbols for identical components were taken over for FIG. 2 and new reference symbols were allocated only for the modified window area. The modified window area of the hearing aid 10′ pursuant to the second embodiment will be discussed in the following.

The hearing aid 10′ pursuant to the second embodiment also has a signal exit window 18′, which on its external surface of the hearing aid, the exit surface 29′, is designed flush with the hearing aid housing 15. Compared with the hearing aid 10 of the first embodiment represented in FIG. 1, the entrance surface 28′ of the window 18′ of the hearing aid 10′ pursuant to the second embodiment, is fitted flush to the surface on the inside of the hearing aid of the hearing aid 10′. Adjacent to the entrance surface 28′, a signal conductor body 47 is arranged which extends in the direction of the LED 25. The signal conductor body 47 can be bonded onto the entrance surface 28′, for example.

The signal conductor body 47 consists of a transparent material and is designed wedge-shaped, wherein the lower end of the wedge bears against the signal exit window 18′, and the tapered upper end is facing towards the LED 25. The signal conductor body 47 comprises an entrance surface 48, which is arranged in the beam direction 26 of the LED 25, so that the entrance surface 48 is irradiated with infrared light. The signal conductor body furthermore comprises an exit surface 49, wherein, and as shown in FIG. 2, a line defined by the surface normal of the exit surface 49 at the point where the refracted optical signal 48a exits the exit surface 49 intersects at an angle with a line defined by the surface normal of the entrance surface 48 at the point where the optical beam contacts the entrance surface. Furthermore, the beam direction 26 of the LED 25 in the embodiment shown in FIG. 2 also runs approximately perpendicular to a line defined by the surface normal 49a of the exit surface 49 where the optical beam exits, so that any light emitted from the diode 25 would not reach the photodiode 39 directly.

Analogous to the embodiment in FIG. 1, the entrance surface 48 of the signal conductor body 47 is tilted towards the beam direction 26 of the diode, so that the infrared light entering into the entrance surface 48 is refracted in the signal conductor body 47. For this purpose, the tilt angle and the material of the signal conductor body 47 are selected such that the infrared light is refracted in the direction 48a towards the surface normal 49a of the exit surface 49.

What is claimed:

1. A hearing aid comprising a hearing aid housing in which is arranged a transmitter unit for transmitting signals containing information to a receiver unit which is outside of the hearing aid, wherein the transmitter unit generates an optical signal in the visible or outside of the visible spectral range and comprises a signal generation means for generating the optical signal and a modulation means for modulating information onto the optical signal, wherein the hearing aid housing comprises a signal exit window that is transparent to the optical signal and through which the optical signal penetrates, wherein the signal exit window has an entrance surface facing the inside of the housing through which the optical signal enters into the signal exit window, and an exit surface that matches the external contour of the hearing aid housing and through which the optical signal exits from the signal exit window, wherein the signal generation means emits the optical signal in a beam direction and is arranged spaced apart from the signal exit window, wherein the beam direction of the signal generation means and a line defined by a normal to the exit surface at a point where the optical signal exits from the signal window intersect at an angle with respect to each other that deviates from zero, and a signal conductor is arranged between the signal generation means and the exit surface so that the optical signal is guided by means of the signal conductor to the exit surface such that an exit direction of the optical signal is normal to the exit surface.

2. The hearing aid according to claim 1, wherein the signal conductor is a rigid signal conductor body made from a material that is transparent to the optical signal and has an entrance surface and an exit surface, wherein the line defined by the normal to the exit surface at the point where the optical signal exits from the signal window and a line defined by a normal to the entrance surface of the signal conductor body intersect at an angle that deviates from zero, and the signal conductor body is arranged and sized such that the entrance surface lies in the beam direction of the signal generation means and onto which the emitted signal can be applied, wherein the material and the normal to the entrance surface are selected such that the optical signal impinging on the entrance surface is refracted towards the normal to the exit surface at the point where the optical signal exits from the signal window.

3. The hearing aid according to claim 2, wherein the signal exit window forms the rigid signal conductor body in that it extends from its exit surface in a direction towards the signal generation means and its entrance surface is in the beam direction of the signal generation means and is arranged so that the emitted signal can be applied onto it.

4. The hearing aid according to claim 1, wherein the signal exit window is produced from a synthetic material that is transparent to the optical signal.

5. The hearing aid according to claim 1, wherein the hearing aid housing is produced from the signal exit window material, wherein the hearing aid housing and the signal exit window are in one piece, and wherein the signal exit window is formed as an integral component of the hearing aid housing.

6. The hearing aid according to claim 5, wherein an outer surface of the hearing aid housing is painted or coated or imprinted except for the signal exit window.

7. The hearing aid according to claim 6, wherein the outer surface of the hearing aid housing is completely painted or coated or imprinted followed by subsequent removal of the painting, coating or imprinting from the signal exit window.

8. The hearing aid according to claim 1, wherein the hearing aid comprises a rechargeable battery and a charging circuit with energy receiving means which operate without making contact, and with acquisition means for detecting a charge status of the battery, wherein the modulation means is in communication with the acquisition means and modulates information onto the signal regarding the charge status.

9. The hearing aid according to claim 1, wherein the hearing aid further comprises counting means for detecting the number of charge cycles or the charge cycles that are still remaining, and wherein the modulation means is in communication with the counting means and modulates information regarding the number of charge cycles or the charge cycles still remaining onto the signal.

10. A charge system consisting of a charge station and a hearing aid according to claim 1, wherein the charge station comprises the receiver unit and demodulation means for reading out the information modulated onto the transmitted signal.
